(19) United States
(12) Patent Application Publication
(10) Pub. No.: US 2026/0092836 A1
(43) Pub. Date: Apr. 2, 2026

(54) PLATFORM BALANCE WITH A TARE ASSEMBLY HAVING A COMPRESSION STRUT

(71) Applicant: ILLINOIS TOOL WORKS INC., Glenview, IL (US)

(72) Inventors: John W. Murray, Golden Valley, MN (US); Victor Senft, Edina, MN (US); Glenn Lucachick, Bloomington, MN (US); Sloan Smith, Wayzata, MN (US)

(21) Appl. No.: 19/343,440

(22) Filed: Sep. 29, 2025

Related U.S. Application Data
(60) Provisional application No. 63/701,945, filed on Oct. 1, 2024.

(51) Int. Cl. G01M 17/007

(52) U.S. Cl. CPC G01M 17/007

(57) ABSTRACT

A platform balance suitable for transmitting forces and moments in a plurality of directions includes a lower and upper frame supporting a platform. At least one tare assembly attaches the two frames, where the tare assembly includes an arm attached to the lower frame with a pivot. A counterweight is attached to the arm on one side of the pivot, and the first end of a compression strut is attached to the arm on a second side of the pivot, with a second end of the compression strut attached to the upper frame. The compression strut includes a set of spaced-apart flexures, each compliant about a horizontal direction, such that the compression strut is configured to be rigid in a vertical direction and compliant in the horizontal direction. The flexure stiffness is tuned, considering the vertical load on the strut, to achieve zero horizontal stiffness of the loaded strut.

### CROSS-REFERENCE TO RELATED APPLICATION(S)

The present application is based on and claims the benefit of U.S. provisional patent application Ser. No. 63/701,945, filed Oct. 1, 2024, the content of which is hereby incorporated by reference in its entirety.

### BACKGROUND

The discussion below is merely provided for general background information and is not intended to be used as an aid in determining the scope of the claimed subject matter.

The present disclosure relates to devices that transmit and measure linear forces along and moments about three orthogonal axes. More particularly, the present disclosure relates to devices that are particularly well suited to measure forces and moments upon a test specimen in a test environment, such as in a wind tunnel.

The measurement of loads, both forces and moments, with accuracy and precision is important to many applications. A common use, where several moments and forces need to be measured, is in the testing of specimens in a wind tunnel. Test specimens can be placed on a platform balance located in a pit of the wind tunnel. The platform balance can be adapted to receive a vehicle or other large test specimen, rather than merely a scale model of the vehicle. Actual vehicles, rather than scale models of the vehicles, allows the designer to determine actual measurements of prototypes, rather than merely inferential measurements. If the test specimen is a vehicle with wheels, the platform balance can be equipped with a rolling belt to rotate the wheels, which can make a significant improvement in measurement accuracy.

Six components of force and moment act on a test specimen on the platform balance in the wind tunnel. These six components are known as lift force, drag force, side force, pitching moment, yawing moment, and rolling moment. The moments and forces that act on the test specimen are usually resolved into three components of force and three components of moment with transducers that are sensitive to the components. Each of the transducers carries sensors, such as strain gages, that are connected in combinations that form Wheatstone bridge circuits. By appropriately connecting the sensors, resulting Wheatstone bridge circuit unbalances can be resolved into readings of the three components of force and three components of moment.

Platform balances typically have one or more tare assemblies comprising a counterweight and a support device on opposite sides of a pivot. The support device supports an upper frame, a rolling road tester and a weight of a vehicle being tested. In typical platform balances, the counterweight is moved to compensate for different vehicle weights, which can increase setup time.

### SUMMARY

An aspect of the present disclosure relates to a platform balance suitable for transmitting forces and moments in a plurality of directions. The platform balance includes a lower frame and an upper frame, coupled by force and or moment measurement devices, supporting a platform. At least one tare assembly is connected to the upper and lower frames, where the tare assembly includes an arm attached to the lower frame with a pivot. A counterweight is attached to the arm on a first side of the pivot, a compression strut having a first end attached to the arm on a second side of the pivot and a second end attached to the upper frame, the compression strut comprising: a first set of spaced apart aligned flexure areas between the first end and the second end along a vertical direction, each flexure area configured to flex such that the compression strut is configured to be rigid in the vertical direction and compliant to rotation about a first horizontal direction orthogonal to the vertical direction and translation in a second horizontal direction orthogonal to the vertical direction, and rotation about the vertical direction.

Implementations may include one or more of the following features. The platform balance where each flexure area of the first set of spaced apart aligned flexure areas between the first end and the second end is configured to flex about the first horizontal direction.

Each flexure area of the first set of spaced apart aligned flexure areas between the first end and the second end can be configured to flex about a plurality of horizontal directions all being orthogonal to the vertical direction.

The compression strut may include a second set of spaced apart aligned flexure areas between the first end and the second end. Each flexure area of the second set of spaced apart aligned flexure areas is substantially orthogonal to the first set of spaced apart aligned flexure areas. Each flexure area of the second set of spaced apart aligned flexure areas is configured to flex about the second horizontal direction such that the compression strut is configured to be rigid in the vertical direction and compliant to translation in the first horizontal direction and the second horizontal direction, compliant to rotation about the first horizontal direction and the second horizontal direction, and compliant to rotation about the vertical direction.

The second set of spaced apart aligned flexure areas can have a same bending stiffness or a different bending stiffness as the first set of spaced apart flexure areas.

In one embodiment, a length between midpoints of the first set of spaced apart aligned flexure areas is substantially a same length between midpoints of the second set of spaced apart aligned flexure areas. Midpoints of the first set of spaced apart aligned flexure areas can be spaced a first length and midpoints of the second set of spaced apart aligned flexure areas can be spaced a second length, where the first length is different from the second length.

Each of the angular bending stiffness of each of the first and/or second sets of spaced apart aligned flexure areas, if present, can be determined by the formula Kₐ=LF/2 where Kₐ is the angular bending stiffness, F is a vertical force imparted on the at least one tare assembly and L is a distance between midpoints of each of the first and/or second sets of spaced apart aligned flexure areas, and where L may be equal or unequal when the first and second sets of spaced apart aligned flexures are present.

The platform balance may include at least one force and/or moment measurement device connected between the upper frame and the lower frame.

The at least one tare assembly may include a plurality of tare assemblies.

The platform balance may include a plurality of force and or moment measurement devices connected between the upper frame and the lower frame.

### BRIEF DESCRIPTION OF THE DRAWINGS

FIG. 1 is a partial cutaway view of a roadway testing assembly.

FIG. 2 an isometric view of a lower frame and turntable of the roadway testing assembly with a plurality of tare assemblies.

FIG. 3 is a side view of a tare assembly.

FIG. 4 is an isometric view of a compression strut of the tare assembly.

FIG. 5 is a flowchart for determining size and location of counterweight and torsional stiffness of flexure areas in the compression strut.

FIG. 6 is a view of the compression strut identifying the rigid and flexible sections.

FIG. 7 is a diagram of the force and moment applied by the upper frame to the compression strut in FIG. 6 when deflected in a horizontal direction.

FIG. 8 is a free body diagram of the central rigid element of the compression strut in FIG. 6 when deflected in a horizontal direction.

FIGS. 9 and 10 are isometric views of other compression struts.

### DETAILED DESCRIPTION

The present disclosure relates to a tare assembly that applies a substantially constant tare force in the z direction and allows for substantially free translation along and rotation about the x, y, and z directions while a platform balance is subjected to any combination of linear forces along and moments about the x, y, and z directions. In an exemplary embodiment, the platform balance utilizes one or more tare assemblies connected to the upper and lower frames of a roadway testing device such that all forces and moments applied to the upper frame, with the exception of the tare force in the z direction, are reacted primarily by force and moment measurement devices.

The one or more tare assemblies have a fixed counterweight on one side of a pivot, coupled to the lower frame, and a compression strut coupled to the upper frame. The compression strut includes at least one set of spaced apart aligned flexure areas in the strut that allow the upper frame to move substantially freely in the first horizontal direction and rotate about the second horizontal direction and vertical direction relative to the lower frame. More typically, the compression strut includes first and second sets of spaced apart aligned flexure areas that are substantially orthogonal to each other, where each of the first and second set of spaced apart flexure areas are substantially a same distance apart, such that the upper frame can move substantially freely in the horizontal or x-y direction and rotate in x, y and z directions when subjected any combination of linear forces along and moments about the x, y, and z directions.

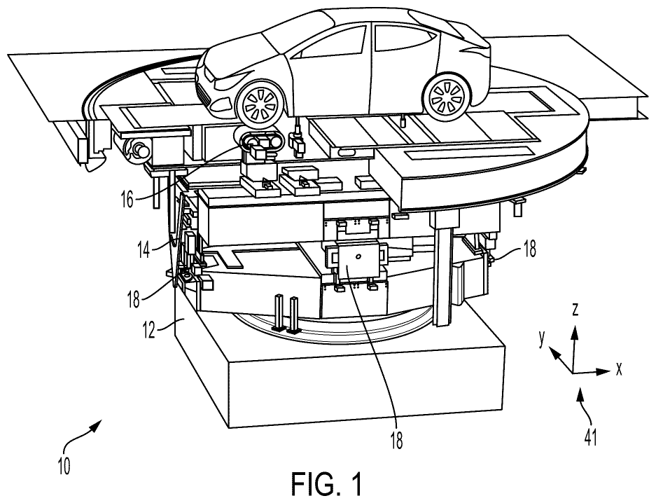

Referring to FIG. 1, a roadway testing assembly is illustrated at 10. The roadway assembly 10 includes a lower frame 12 to which an upper frame 14 supporting a platform assembly 16 is coupled with a plurality of transducers 18 and tare assemblies (not illustrated) in FIG. 1. In the illustrated embodiment, the platform assembly 16 retains a plurality of roadway simulators (not illustrated) or rolling roads that simulate the movement of a vehicle 19 on a road.

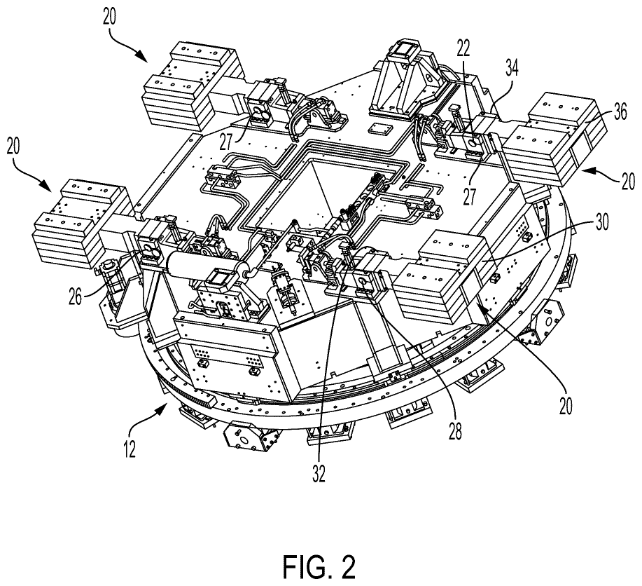

Referring to FIGS. 1 and 2, the tare assemblies 20 are constructed to allow the upper frame 14 and platform assembly 16 to move substantially freely in the x, y and z directions and to rotate in the x, y and z directions. In general, the one or more tare assemblies support the static weight of the upper frame 14, platform assembly 16, roadway simulators 18 and test specimen, while transducer(s) connected between the upper frame and the lower frame measure any combination of linear forces along and moments about the x, y, and z directions applied to or by the test specimen and through the platform 16 and upper frame 14 such as aero dynamic loading on a vehicle.

Referring to FIG. 2, the roadway testing assembly 10 includes four tare assemblies 20, one for each wheel of a vehicle. However, it is understood that the one or more tare assemblies 20 can be utilized depending upon a desired application.

Each of the plurality of tare assemblies 20 is similarly constructed such that a single tare assembly 20 will be described in detail. The tare assembly 20 is mounted to the lower frame 12 with a mounting bracket 27 having a pivot 22. An arm 24 of the tare assembly 20 is secured within clamping bores 26 within clamping portions 28, 30 of a mounting bracket 27 on opposite sides of the arm 24. The clamping portions 28 and 30 each include a slot 32 that intersects the clamping bore 26 where a bolt 34 engages a threaded bore below the slot 32. The threaded engagement of the bolt 34 with the threaded bore constricts the clamping bore(s) 26 to non-movably retain the pivot 22 to the mounting bracket 27.

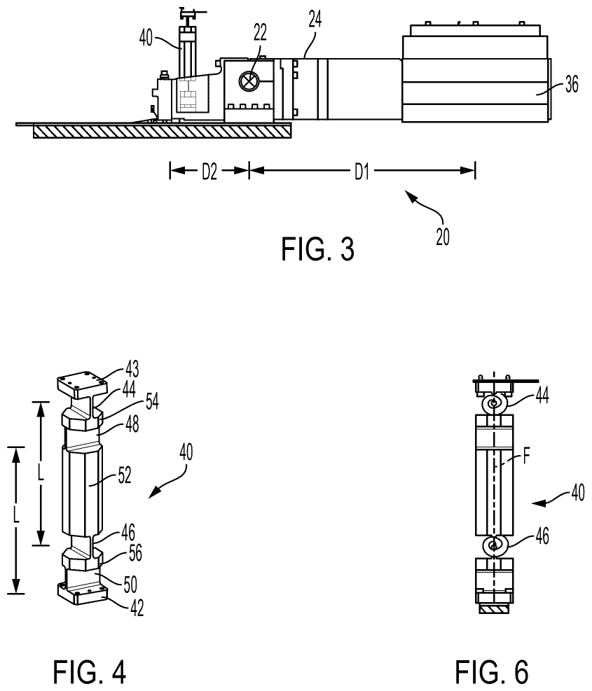

Referring to FIGS. 2 and 3, the tare assembly 20 includes counterweight(s) 36 attached to the arm 24 a distance from the pivot 22. A distance between a center of gravity of the counterweights 36 and the axis of rotation of the pivot 22 is illustrated as D1 in FIG. 3. The counterweight(s) 36 are fixedly attached to the arm 24, such that the counterweight(s) 36 are in a same location for a range of loads on the platform 16.

The tare assembly 20 includes a compression strut 40 attached to the arm 24 on an opposite side of the pivot 22. A center of the compression strut 40 when attached to the arm 24 is a distance D2 to the axis of rotation of the pivot 22.

The compression strut 40 includes a bottom mounting plate 42 that is secured to the arm 24 with a plurality of bolts and a top mount plate 43 that is secured to the upper frame 14, also with a plurality of bolts. The compression strut 40 thereby couples the upper frame 14 to the lower frame 12 through the tare assembly 20 to allow the upper frame 14 and the platform 16 to substantially freely move in the x, y and z directions and to rotate in the x, y and z directions as described below while introducing a substantially constant upward force in the z direction. FIG. 1 illustrates a reference coordinate system at 41.

The compression strut 40 includes spaced apart aligned first flexure areas 44 and 46, where midpoints of each of the first flexure areas 44 and 46 are spaced a distance L. In the embodiment illustrated, the compression strut 40 also includes spaced apart aligned second flexure areas 48 and 50, where the midpoints of each of the second flexure areas 48 and 50 is a same distance L as the distance between the midpoints of the first flexure areas 44 and 46. The first spaced apart flexure areas 44 and 46 are oriented substantially orthogonal to the second spaced apart flexure areas 48 and 50 to allow for all movement within an x-y plane that is substantially parallel to a plane of the platform 16.

The compression strut 40 includes a rigid middle portion 52 between the second flexure area 48 and the first flexure area 46, a top portion 54 between the first flexure area 44 and the second flexure area 48 and a bottom portion 56 between the first flexure area 46 and the second flexure area 50. The rigid portions 52, 54 and 56 are significantly stiffer than the first flexure areas 44 and 46 and the second flexure areas 48 and 50 such that when a vertical tare force and an overturning moment is placed on the platform 16, the movement of the strut 40 occurs in the first flexure areas 44 and 46 and/or the second flexure areas 48 and 50.

Orienting the first set of flexure areas 44 and 46 and the second spaced apart flexure areas 48 and 50 substantially orthogonal and spaced the same distance L with the rigid portions 52, 54 and 56 therebetween results in the compression strut 40 being very stiff in the vertical or z direction while being compliant in the x and y directions and the rotational axes in x, y and z.

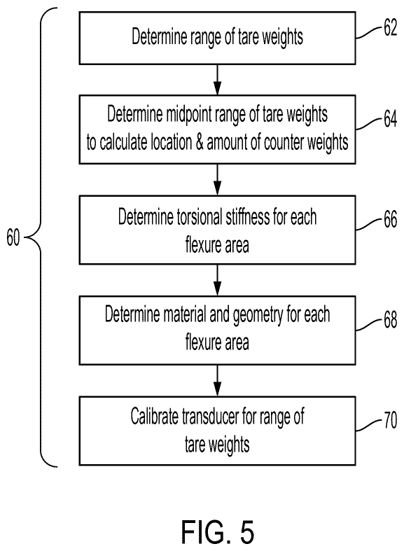

The tare assemblies 20 are tuned or balanced for an application using a method 60 illustrated in FIG. 5. The method 60 includes a step of determining a range of tare weights that the roadway testing assembly 10 will encounter at 62 for a particular application. The method 60 then includes determining a midpoint of the range of tare weights, which is used to calculate a location and mass of the counterweight(s) 36 for each tare assembly 20 at step 64. In order to obtain substantially zero horizontal stiffness in the compression struts 40, a torsional stiffness for each flexure area 44, 46, 48 and 50 is determined step 66.

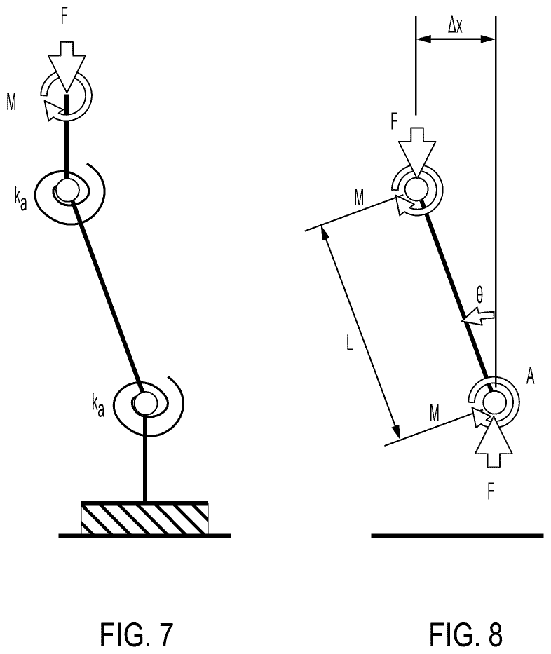

Referring to FIGS. 6-8, a schematic drawing of a load which includes the vertical force F and the overturning moment M about a horizontal axis orthogonal to the horizontal axis of deflection is illustrated which creates moments 80 and 82 in the flexure areas 44 and 46. Note that there is no horizontal component to the applied load. As the vertical load on the compression strut 40 is known, a length L between the midpoints of the first and second flexure areas is known and an angle of flexure from vertical can be estimated, the required bending stiffness, considered to be equivalent to a torsional stiffness at the midpoint of each flexure area 44 and 46 for a single flexure area, can be determined by the following equation:

$${K}_{a} = L sin ( θ ) F / 2 θ \qquad ( Equation 1 )$$

However, when θ is sufficiently small, Equation 1 can be simplified using the small angle approximation as follows:

$${K}_{a} = LF / 2 \qquad ( Equation 2 )$$

Thus, when θ is sufficiently small, Equation 2 shows that the required stiffness Kₐ to result in zero horizontal load is constant for a given length L and vertical load F.

After the bending stiffness of each flexure area 44, 46, 48 and 50 is determined, the type of material used and the geometry of each flexure area 44, 46, 48 and 50 can be determined at step 68.

With the counterweight location and mass determined and the torsional stiffness for each flexure area in each compression strut determined, a transducer can be utilized that tolerates variations in weight within the weight range at step 70.

In other embodiments, the compression strut can be configured with a first set of aligned flexure areas having a first bending stiffness Kₐ₁ determined from Equations 1 and 2 having bending midpoints spaced a distance L₁ and a second set of aligned flexure areas that are orthogonal to the first aligned flexure areas and have a second bending stiffness Kₐ₂ and have bending midpoints spaced a distance L₂. The bending stiffness Kₐ₁ and the bending stiffness Kₐ₂ are different and the distance between the bending midpoints L₁ and L₂ are different. The first and second sets of aligned flexures are tuned, as discussed above, to allow for substantially free translation along and rotation about the x, y, and z directions while a platform balance is subjected to any combination of linear forces along and moments about the x, y, and z directions.

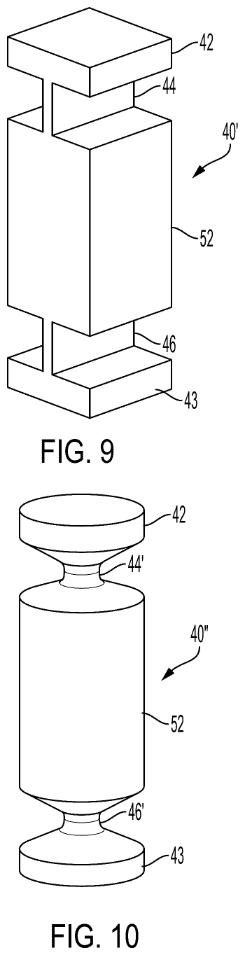

At this point, it should be noted that the invention is not limited to strut 40 having two sets of flexure areas. For example, if only a single direction of compliance is needed, such as in the x direction, a single set of flexure areas, such as the first flexure areas 44 and 46 are provided as illustrated in strut 40′ in FIG. 9. A further embodiment of a strut is illustrated in FIG. 10 at 40″. In strut 40″, spaced apart flexure areas 44″ and 46″ are present. Similar structure as found in strut 40 is identified with the same reference numbers.

Although the struts 40, 40′ and 40″ have different degrees of compliance, each of the struts 40, 40′ and 40″ due to the flexure areas of the first set of spaced apart aligned flexure areas 44 and 46 of strut 40 and 40′, and flexure areas 44″ and 46″ of strut 40″, each of the struts 40, 40′ and 40″ is configured to flex such that the struts 40, 40′, 40″ is configured at least to be rigid in the vertical or z direction and compliant to rotation about a first horizontal direction (e.g. x direction) orthogonal to the vertical direction and translation in a second horizontal direction (e.g. y direction) orthogonal to the vertical direction, and rotation about the vertical direction. In one embodiment, each flexure area 44 and 46 of strut 40 and 40′, and flexure areas 44″ and 46″ can be considered as being configured to flex about the first horizontal direction.

With respect to strut 40, each flexure area 48, 50 of the second set of spaced apart aligned flexure areas is configured to flex about the second horizontal direction such that the compression strut 40 is configured to be rigid in the vertical direction and compliant to translation in the first horizontal direction and the second horizontal direction, compliant to rotation about the first horizontal direction and the second horizontal direction, and compliant to rotation about the vertical direction.

With respect to strut 40″, each flexure area 44′ and 46′ is configured to flex about a plurality of horizontal directions all being orthogonal to the vertical direction, such that the compression strut 40″ is configured to be rigid in the vertical direction and compliant to translation in the first horizontal direction and the second horizontal direction, compliant to rotation about the first horizontal direction and the second horizontal direction, and compliant to rotation about the vertical direction.

The disclosure, including the figures, describes a platform balance. However, it should be noted that the present invention could be implemented in other devices or structures, as well. The present invention is described with respect to the frame supports for illustrative purposes only. Other examples are contemplated or are otherwise imaginable to someone skilled in the art. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

Although the present disclosure has been described with reference to preferred embodiments, workers skilled in the art will recognize that changes may be made in form and detail without departing from the spirit and scope of the disclosure.

1. A platform balance suitable for transmitting forces and moments in a plurality of directions, the platform balance comprising:
a lower frame;
an upper frame supporting a platform; and
at least one tare assembly connected to the upper frame and the lower frame, the tare assembly comprising:
an arm attached to the lower frame with a pivot;
a counterweight attached to the arm on a first side of the pivot; and
a compression strut having a first end attached to the arm on a second side of the pivot and a second end attached to the upper frame, the compression strut comprising:
a first set of spaced apart aligned flexure areas between the first end and the second end along a vertical direction, each flexure area configured to flex such that the compression strut is configured to be rigid in the vertical direction and compliant to rotation about a first horizontal direction orthogonal to the vertical direction and translation in a second horizontal direction orthogonal to the vertical direction, and rotation about the vertical direction.

2. The platform balance of claim 1, wherein each flexure area of the first set of spaced apart aligned flexure areas between the first end and the second end is configured to flex about the first horizontal direction.

3. The platform balance of claim 2, wherein each flexure area of the first set of spaced apart aligned flexure areas between the first end and the second end is configured to flex about a plurality of horizontal directions all being orthogonal to the vertical direction.

4. The platform balance of claim 1, wherein the compression strut comprises a second set of spaced apart aligned flexure areas between the first end and the second end.

5. The platform balance of claim 4, wherein each flexure area of the second set of spaced apart aligned flexure areas is substantially orthogonal to the first set of spaced apart aligned flexure areas.

6. The platform balance of claim 5, wherein each flexure area of the second set of spaced apart aligned flexure areas is configured to flex about the second horizontal direction such that the compression strut is configured to be rigid in the vertical direction and compliant to translation in the first horizontal direction and the second horizontal direction, compliant to rotation about the first horizontal direction and the second horizontal direction, and compliant to rotation about the vertical direction.

7. The platform balance of claim 4, wherein the second set of spaced apart aligned flexure areas has a same bending stiffness as the first set of spaced apart flexure areas.

8. The platform balance of claim 7, wherein a length between midpoints of the first set of spaced apart aligned flexure areas is substantially a same length between midpoints of the second set of spaced apart aligned flexure areas.

9. The platform balance of claim 4, wherein the second set of spaced apart aligned flexure areas has a different bending stiffness as the first set of spaced apart flexure areas.

10. The platform balance of claim 9, wherein midpoints of the first set of spaced apart aligned flexure areas are spaced a first length and midpoints of the second set of spaced apart aligned flexure areas are spaced a second length, where the first length is different from the second length.

11. The platform balance of claim 1, wherein the counterweight is non-movably attached to the arm.

12. The platform balance of claim 1, and further comprising at least one force and/or moment measurement device connected between the upper frame and the lower frame.

13. The platform balance of claim 1, wherein the at least one tare assembly comprises a plurality of tare assemblies.

14. The platform balance of claim 13, and further comprising a plurality of force and or moment measurement devices connected between the upper frame and the lower frame.

15. The platform balance of claim 4, wherein an angular bending stiffness of each of the first and second sets of spaced apart aligned flexure areas is determined by the formula
Kₐ=LF/2
where Kₐ is the angular bending stiffness, F is a vertical force imparted on the at least one tare assembly and L is a distance between midpoints of each of the first and second sets of spaced apart aligned flexure areas, and where L may be equal or unequal for the first and second sets of spaced apart aligned flexures.

16. The platform balance of claim 1, wherein an angular bending stiffness of each flexure areas of the first set of spaced apart aligned flexure areas is determined by the formula
Kₐ=LF/2
where Kₐ is the angular bending stiffness, F is a vertical force imparted on the at least one tare assembly and L is a distance between midpoints of the first set of spaced apart aligned flexure areas.
